(19) United States
(12) Patent Application Publication
(10) Pub. No.: US 2006/0092356 A1
(43) Pub. Date: May 4, 2006

(54) Liquid crystal display device

(75) Inventors: Masateru Morimoto, Mobara (JP); Hirotaka Imayama, Mobara (JP); Takahiro Ochiai, Chiba (JP); Oasamu Itou, Hitachi (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 11/242,042

(22) Filed: Oct. 4, 2005

(30) Foreign Application Priority Data
Oct. 29, 2004 (JP) 2004-315519

(51) Int. Cl. G02F 1/1335

(52) U.S. Cl. 349/114

(57) ABSTRACT

The present invention provides a transmission-type, partial-transmission-type or a semi-transmission-reflection-type lateral electric field driving liquid crystal display device which can obtain the favorable transmissivity even when a circulatory polarized light is incident on a liquid crystal layer from a back surface side. In a liquid crystal display device which includes a first substrate which has a pixel electrode and a counter electrode, a second substrate which is arranged to face the first substrate in an opposed manner, a liquid crystal layer which is sandwiched between the first substrate and the second substrate, an upper polarizer which is arranged at a front surface side than the liquid crystal layer, and a lower polarizer which is arranged at a back surface side than the liquid crystal layer, the liquid crystal display device further includes a lower phase difference film which is arranged between the liquid crystal layer and the lower polarizer and converts a linearly polarized light to a circularly polarized light and an upper phase difference film which is arranged between the liquid crystal layer and the upper polarizer, the liquid crystal layer is driven by an electric field which is generated between the pixel electrode of the first substrate and the counter electrode of the first substrate, and a twist angle of the liquid crystal layer is within a range of 50° to 120° to perform a black display when a voltage is not applied.

Priority is claimed based on Japanese Patent Application No. 2004-315519 filed on Oct. 29, 2004, all of which is incorporated by reference.

The present application claims priority from Japanese application JP2004-315519 filed on Oct. 29, 2004, the content of which is hereby incorporated by reference into this application.

### BACKGROUND OF THE INVENTION

The present invention relates to a liquid crystal display device, and more particularly to a liquid crystal display device having pixel electrodes and counter electrodes on a liquid-crystal-side pixel region of one substrate out of respective substrates which are arranged to face each other in an opposed manner with liquid crystal therebetween.

This kind of liquid crystal display device is referred to as a so-called IPS type liquid crystal display device and is known as a display device which can drive liquid crystal based on components of an electric field which are arranged substantially parallel to the substrate and exhibits the excellent broad viewing angle characteristic.

On the other hand, as a liquid crystal display device which is compared with this kind of liquid crystal display device, there exists a so-called vertical electric field liquid crystal display device, wherein with respect to a pair of electrodes which drive liquid crystal, a pixel electrode is formed on a liquid-crystal-side surface of one substrate and a counter electrode is formed on a liquid-crystal-side surface of another substrate.

The vertical electric field liquid crystal display device has been applied to a display device of a mobile phone and there have been known various types of liquid crystal display devices which include a transmission region and a reflection region on each pixel.

In these liquid crystal display devices, a so-called backlight is provided to a back surface of a liquid crystal display panel and, when necessary, light from the backlight is allowed to pass through the liquid crystal display panel to a viewer's side or the backlight is interrupted and an external light such as sun beams is allowed to pass through the liquid crystal and, thereafter, is reflected on the viewer's side.

However, in such a liquid crystal display device, the light which passes through the reflection region has an optical path length in the liquid crystal approximately twice as long as an optical path length of the light which passes through the transmission region. To cope with such a phenomenon, there has been usually proposed a technique which sets a layer thickness of a liquid crystal in the reflection region approximately ½ of a layer thickness of the liquid crystal in the transmission region by forming a step on a layer which faces the liquid crystal.

In the same manner, also with respect to the so-called IPS type liquid crystal display device, there has been known the liquid crystal display device which is applied to a display of a mobile phone. However, the liquid crystal display device fails to obtain advantageous effects of the present invention described in detail hereinafter.

Here, all of Japanese Patent Laid-Open Hei9(1997)-329813 (patent document 1), Japanese Patent Laid-Open 2002-98961 (patent document 2)and Japanese Patent Laid-Open 2002-48917 (patent document 3) disclose the constitutions similar to the constitution of the present invention with respect to a portion of constitutional feature of the present invention. That is, the patent document 1 discloses an IPS liquid crystal display device, wherein a transmission-type display device, a reflection-type display device, a twist angle and a rubbing angle are described. However, the patent literature 1 fails to disclose a semi-transparent or partially transparent display device. Further, the patent document 1 also fails to disclose the incidence of a circularly polarized light.

On the other hand, both of the patent document 2 and the patent document 3 disclose the incidence of a circularly polarized light.

### SUMMARY OF THE INVENTION

As described the above, the so-called vertical electric field liquid crystal display device which includes the transmission regions and the reflection regions (hereinafter also referred to as a partial transmission type liquid crystal display device) possesses the step on the layer which faces the liquid crystal and hence, the disturbance is generated in the orientation of liquid crystal molecules in the stepped portion whereby it is unavoidable that leaking of light is generated here thus deteriorating the image quality.

Further, in the usual vertical electric field method, the direction that the liquid crystal rises is uni-directional and hence, there exists a drawback that the direction at which a tone of an image is inverted when a screen is observed obliquely is present.

Accordingly, the present invention has been made under such circumstances and it is an advantage of the present invention to provide a liquid crystal display device which can reduce the difference in layer thickness of liquid crystal between a transmission region and a reflection region or which can eliminate such difference.

Further, it is another advantage of the present invention to provide a liquid crystal display device having a wide viewing angle (a tone of a display image hardly inverted when a screen is viewed obliquely).

It is still another advantage of the present invention to provide, with respect to anyone of transmission-type, partial transmission-type and semi-transmission-reflection-type lateral-electric field driving liquid crystal display device, a liquid crystal display device which exhibits the favorable transmissivity even when a circularly polarized light is incident on a liquid crystal layer from a back surface side.

Here, prier to the explanation of the summary of the present invention, a principle which allows the present invention to obtain the above-mentioned advantages is explained first of all.

The present invention adopts a so-called normally black display mode in which a black display is performed when a voltage is not applied.

Further, to realize the normally black display in a state that the step is not formed in a boundary between the transmission region and the reflection region or the step is small, it is necessary to allow the light on a reflection surface (a position where the reflection layer is formed, an opening portion or a gap at a position where a reflection layer is formed in case of the partial transmission type liquid crystal display device or a position of a semi-transmission-reflection film in case of a semi-transparent-reflection liquid crystal display device) to assume a circularly polarized state. Accordingly, the present invention adopts a circularly polarized light as an incident light to the liquid crystal from a back surface side.

In the driving of the so-called vertical electric field type liquid crystal display device, when there is no step between the transmission region and the reflection region (when the layer thickness of the liquid crystal layer is equal between the transmission region and the reflection region), the optical characteristics in the transmission region and the reflection region do not agree with each other as shown in a graph of FIG. 1 and a black display is performed in the reflection region when the transmission region exhibits the maximum transmissivity (drawback attributed to the inversion of characteristic ). Here, in the graph shown in FIG. 1, voltage (V) is taken on an axis of abscissas and brightness (B) is taken on an axis of ordinates. Further, the characteristic indicated by a solid line expresses the characteristic of the transmission light TM and the characteristic indicated by a dotted line expresses the characteristic of the reflection light RM.

To overcome such a drawback, the present invention adopts the lateral electric field driving as a driving method instead of the vertical electric field driving. Here, the lateral electric field driving is a method which arranges both of pixel electrodes and counter electrodes on one substrate out of a pair of substrates which sandwich liquid crystal therebetween and drives liquid crystal by an electric field which is generated between the pixel electrodes and the counter electrodes. One example of the lateral electric field driving is shown in FIG. 2. Here, FIG. 2 shows, as an example of the lateral electric field driving in general, a case in which the orientation directions of respective orientation films of a pair of substrates are arranged parallel to or inversely parallel to each other and a twist angle of the liquid crystal assumes 0° when the voltage is not applied. In the same manner as FIG. 1, voltage (V) is taken on an axis of abscissas and brightness (B) is taken on an axis of ordinates. Further, the characteristic indicated by a solid line expresses the characteristic of the transmission light TM and the characteristic indicated by a dotted line expresses the characteristic of the reflection light RM. It is understood that although the difference is generated between the voltage which is necessary for obtaining the maximum transmissivity and the voltage which is necessary for obtaining the maximum reflectance in the lateral electric field driving, the above-mentioned drawback on the inversion of the characteristic is largely overcome compared to the vertical electric field driving. Further, the liquid crystal can be driven in a state that the rise of the liquid crystal is suppressed due to the lateral electric field driving and hence, it is possible to prevent the inversion of a tone of a display image when a screen is viewed obliquely.

Here, what must be taken into consideration is that, as can be understood from FIG. 2, the brightness of transmission display is lower than the brightness of the reflection display in the usual lateral electric field driving method. Inventors of the present invention have studied various countermeasures to cope with such a phenomenon and, the inventors have finally found that it is extremely effective to apply twisting to the liquid crystal when the voltage is not applied to enhance the brightness when the incident light formed of the circularly polarized light is used in the lateral electric field driving.

A twist angle of a liquid crystal layer in this specification implies, unless otherwise explicitly expressed particularly, a twist angle of the liquid crystal layer when the voltage is not applied. Accordingly, when the expression “90° twisting”, for example, is used in this specification, this implies that the twisting of 90° is applied to the liquid crystal layer when the voltage is not applied.

FIG. 3 shows the electrooptic characteristic of the transmission portion when the twisting is applied to the liquid crystal, wherein voltage (V) is taken on an axis of abscissas and brightness (B) is taken on an axis of ordinates. Curves sequentially indicate a case in which the 0° twisting (0° TW) is applied to the liquid crystal, a case in which the 250 twisting (25° TW) is applied to the liquid crystal, a case in which the 50° twisting (50° TW) is applied to the liquid crystal, a case in which the 90° twisting (90° TW) is applied to the liquid crystal, and a case in which the 70° twisting (70° TW) is applied to the liquid crystal in order from a lower side to an upper side in the drawing. As can be clearly understood from FIG. 3, the brightness of the transmission portion can be largely enhanced by increasing the twist angle.

In FIG. 3, when the twist angle is set to 50° to 90°, no noticeable brightness difference is generated among these twist angles. However, when the twist angle of 50° to 90° is compared with the twist angle of 0° to 25°, the remarkable enhancement of the brightness is observed. Here, as will be explained later in conjunction with FIG. 13 and FIG. 14, it is preferable to set the twist angle to a value which falls within a range of 50° to 120°. The more preferable range of the twist angle is from 60° to 80°.

Here, such an advantage is applicable not only to the partial-transmission type or semi-transmission-reflection-type liquid crystal display device described in this embodiment but also the transmission type liquid crystal display device which forms the transmission region over the whole area of a pixel region.

Such an advantage that the transmissivity can be enhanced by applying the twisting to the liquid crystal layer is observed only when circularly polarized light is incident on the liquid crystal, and the advantage can not be recognized with the linearly polarized light incidence which is generally used in the conventional transmission-type lateral electric field driving liquid crystal display device, for example.

As a reference, FIG. 4 shows the electrooptic characteristic when the twisting is applied to the liquid crystal layer in the lateral electric field driving liquid crystal display device adopting the linearly polarized light incidence. In this case, even when the twisting is applied to the liquid crystal layer, as can be clearly understood from a portion surrounded by a circular frame in the drawing, the brightness is not substantially changed. Here, the portion surrounded by the circular frame in the drawing shows a voltage in the vicinity of the voltage where the characteristic of reflectance not shown in the drawing becomes maximum and is a voltage which is actually used in driving the liquid crystal.

Further, as an additional advantage which is brought about by giving the twist angle in the above-mentioned manner, as shown in a graph of FIG. 5, it is found that the irregularities of a black display attributed to the fluctuation of a thickness of the liquid crystal when the circularly polarized light is incident on the liquid crystal can be reduced. In the graph shown in FIG. 5, the twist angle TW (°) is taken on an axis of abscissas and the brightness (Bb) of the black display is taken on an axis of ordinates. The respective characteristic curves show cases when the fluctuation of the thickness of the liquid crystal is 0.1 μm, 0.2 μm and 0.3 μm in order from below. To be more specific, the respective characteristic curves are obtained by a simulation which consider cases in which the thickness of the liquid crystal become 3.9 μm, 3.8 μm and 3.7 μm respectively while assuming a designed value of the thickness of the liquid crystal as 4 μm. As can be understood form FIG. 5, the larger the twist angle, a margin for the fluctuation of the layer thickness of the liquid crystal is increased.

On the premise of the above-mentioned explanation, to briefly explain the summary of typical inventions among the inventions disclosed in this specification, they are as follows.

(1) In a liquid crystal display device which includes a first substrate which has a pixel electrode and a counter electrode, a second substrate which is arranged to face the first substrate in an opposed manner, a liquid crystal layer which is sandwiched between the first substrate and the second substrate, an upper polarizer which is arranged at a front surface side than the liquid crystal layer, and a lower polarizer which is arranged at a back surface side than the liquid crystal layer, the liquid crystal display device further includes a lower phase difference film which is arranged between the liquid crystal layer and the lower polarizer and converts a linearly polarized light to a circularly polarized light and an upper phase difference film which is arranged between the liquid crystal layer and the upper polarizer, the liquid crystal layer is driven by an electric field which is generated between the pixel electrode of the first substrate and the counter electrode of the first substrate, and a twist angle of the liquid crystal layer is within a range of 50° to 120° to perform a black display when a voltage is not applied.

(2) In the constitution (1), the present invention is characterized in that the twist angle of the liquid crystal layer is set to a value which falls within a range of 60° to 80° when the voltage is not applied.

(3) In the constitution (1) or (2), the present invention is characterized in that the liquid crystal display device includes a reflection region which performs a display by reflecting light which is incident from the front surface side and a transmission region which performs a display by allowing light which is incident from the back surface side to pass therethrough.

(4) In the constitution (3), the present invention is characterized in that the reflection region includes a reflection layer which reflects the light which is incident from the front surface side in place between the lower phase difference film and the liquid crystal layer.

(5) In the constitution (3) or (4), the present invention is characterized in that a layer thickness of the liquid crystal layer in the reflection region and a layer thickness of the liquid crystal layer in the transmission region are substantially equal.

(6) In the constitution (1) or (2), the present invention is characterized in that a semi-transmission-reflection film which is semitransparent and has both of a transmission characteristic and a reflection characteristic is arranged in place between the lower phase difference film and the liquid crystal layer.

(7) In the constitution (1) or (2), the present invention is characterized in that the liquid crystal display device is capable of performing a reflection display in which a display is performed by reflecting light which is incident from the front surface side and a transmission display in which a display is performed by allowing light which is incident from the back surface side to pass through, and a relationship 0.75 dt≦dr≦1.1 dt is established when a layer thickness of the liquid crystal layer at a place where the reflection display is performed is set as dr and a layer thickness of the liquid crystal layer at a place where the transmission display is performed is set as dt.

(8) In the constitution (7), the present invention is characterized in that a relationship 0.9 dt≦dr≦1.1 dt is established.

(9) In the constitution (7) or (8), the present invention is characterized in that the place where the reflection display is performed and the place where the transmission display is performed are arranged at places different from each other in a plan view.

(10) In the constitution (7) or (8), the present invention is characterized in that the place where the reflection display is performed and the place where the transmission display is performed have at least one portion thereof overlapped to each other in a plan view.

(11) In any one of the constitutions (1) to (10), the present invention is characterized in that the liquid crystal display device includes a backlight which is arranged at a back surface side than the lower polarizer.

Here, in this specification, the polarizer includes, for example, a polarization plate, a polarization film, a coating-type polarization film and the like. Further, the phase difference film includes, for example, a phase plate (also referred to as a phase difference plate), a phase film (also referred to as a phase difference film), a wave plate (also referred to as a quarter-wave plate, a half-wave plate or the like), a coating-type phase film (also referred to as a phase difference film) and the like. Here, the phase difference film may be constituted of single plate or may be constituted of a combination of two or more plates. Further, the front surface side and the back surface side respectively imply a front surface side and a back surface side as viewed from a viewer.

The present invention is not limited to the above-mentioned constitutions and various modifications are conceivable without departing form a technical concept of the present invention.

### BRIEF DESCRIPTION OF THE DRAWINGS

FIG. 1 is a B-V characteristic diagram in a transmission region and a reflection region when the vertical electric field driving is performed;

FIG. 2 is a B-V characteristic diagram in a transmission region and a reflection region when the lateral electric field driving is performed;

FIG. 3 is a B-V characteristic diagram in a transmission region when a circularly polarized light is incident in the case that twisting is applied to liquid crystal in the lateral electric field driving;

FIG. 4 is a B-V characteristic diagram in a transmission region when a linear polarized light is incident in the case that twisting is applied to liquid crystal in the lateral electric field driving;

FIG. 5 is a view showing irregularities of a black display attributed to the fluctuation of a thickness of liquid crystal in a transmission region when a circularly polarized light is incident in the case that a twist angle applied to liquid crystal is changed in the lateral electric field driving;

FIG. 6 is a cross-sectional view showing one embodiment of the constitution of a liquid crystal display device to which the present invention is applied;

FIG. 7 is a cross-sectional view showing another embodiment of the constitution of the liquid crystal display device to which the present invention is applied;

FIG. 8 is a cross-sectional view showing another embodiment of the constitution of the liquid crystal display device to which the present invention is applied;

FIG. 9 is a cross-sectional view showing another embodiment of the constitution of the liquid crystal display device to which the present invention is applied;

FIG. 10 is a cross-sectional view showing another embodiment of the constitution of the liquid crystal display device to which the present invention is applied;

FIG. 11 is a cross-sectional view showing another embodiment of the constitution of the liquid crystal display device to which the present invention is applied;

FIG. 12 is an explanatory view showing a twist angle and a rubbing angle in the liquid crystal display device to which the present invention is applied;

FIG. 13 is a characteristic diagram showing the brightness in a transmission region and a reflection region when a twist angle applied to liquid crystal is changed;

FIG. 14 is a B-V characteristic diagram in a transmission region when a twist angle applied to the liquid crystal is changed;

FIG. 15 is a characteristic diagram showing the brightness with respect to a rubbing angle when the twist angle applied to the liquid crystal is set to a value which falls within a range of 50° to 120°; and

FIG. 16 is an exploded view showing properties of respective optical elements including a liquid crystal display panel of the liquid crystal display device to which the present invention is applied.

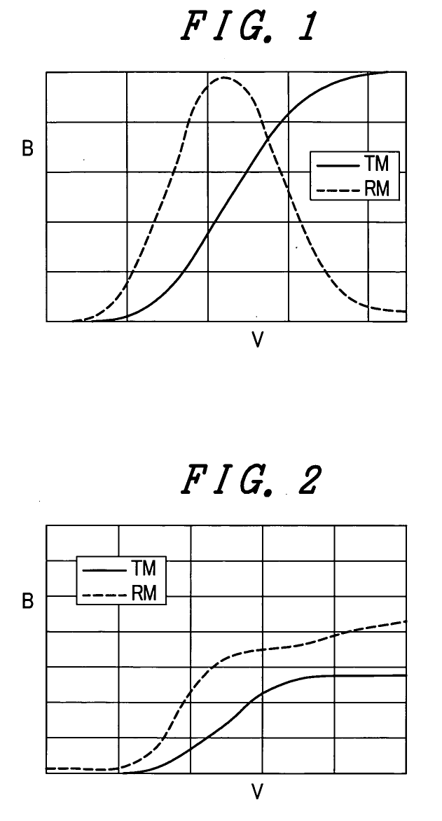

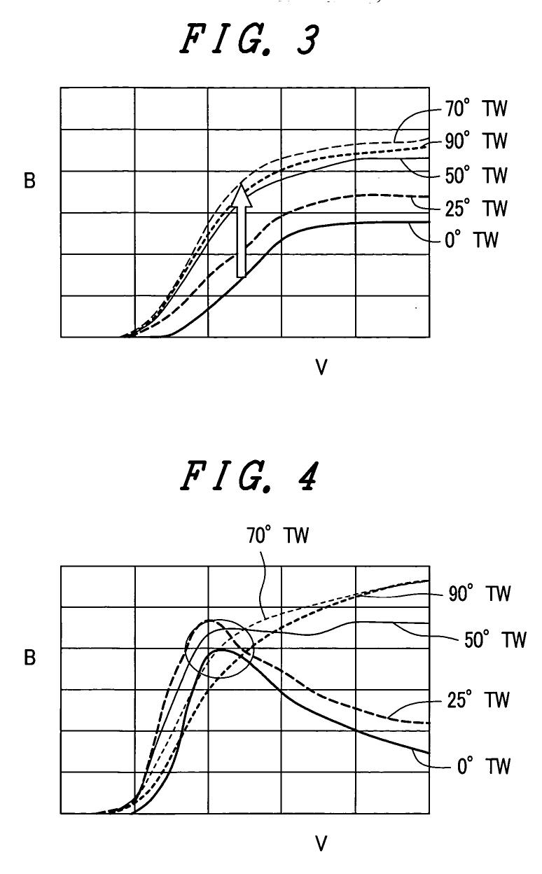

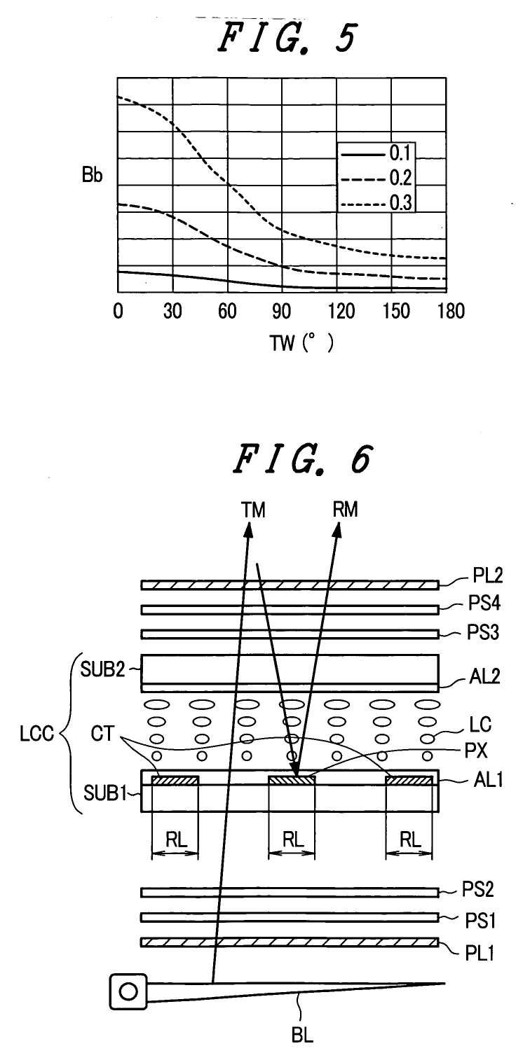

### DESCRIPTION OF THE PREFERRED EMBODIMENTS

Embodiments of a liquid crystal display device according to the present invention are explained in conjunction with attached drawings hereinafter.

FIG. 6 is a cross-sectional view showing one embodiment of the liquid crystal display device according to the present invention. This embodiment shows an example in which the present invention is applied to a partial transmission type liquid crystal display device.

Here, with respect to a liquid crystal display panel (liquid crystal cell) LCC shown in FIG. 6, for facilitating the explanation, a cross section of only a portion which corresponds to one pixel among respective pixels which are arranged in a matrix array, for example is shown.

The liquid crystal display panel LCC is configured by adopting transparent substrates SUB1, SUB2 which are arranged to face each other with liquid crystal LC therebetween as an envelope. The transparent substrate SUB2 is arranged on a viewer's side (upper side in the drawing) and the transparent substrates SUB1 is arranged on a backlight BL side which is described later.

On a pixel region formed on a liquid-crystal-side surface of the transparent substrate SUB1, pixel electrodes PX and counter electrodes CT are formed. These pixel electrodes PX and counter electrodes CT are formed of a strip-like pattern, are arranged in an extending manner from a front side to a back side of the drawing, and are alternately arranged while maintaining a given distance therebetween in order of the counter electrode CT, the pixel electrode PX, the counter electrode CT, . . . in the direction orthogonal to the extending direction.

Electric fields which are applied to the liquid crystal LC are generated between the pixel electrodes PX and the counter electrodes CT, wherein molecules of the liquid crystal LC are activated due to components of these electric fields which are arranged parallel to the surface of the transparent substrate SUB1.

Both of the pixel electrodes PX and the counter electrodes CT are made of metal such as A1 or the like which exhibits the favorable light reflectance. Accordingly, as viewed in a plan view, places of the pixel region where the pixel electrodes PX and the counter electrodes CT are formed are constituted as reflection regions RL and other remaining places are constituted as transmission regions.

Here, an orientation film AL1 is formed on the front surface of the transparent substrate SUB1 in a state that the orientation film AL1 also covers the pixel electrodes PX and the counter electrodes CT. The orientation film AL1 is a film which is directly brought into contact with the liquid crystal LC and determines the initial orientation direction of the molecules of the liquid crystal LC by setting the rubbing direction of the orientation film AL1.

Here, in the above-mentioned explanation, for facilitating the explanation, one pixel portion is shown in an enlarged manner and only the pixel electrode PX, the counter electrodes CT and the orientation film AL are shown in the pixel region. In view of the above, it is needless to say that other constitutional members are added and arranged besides the above-mentioned constitutional members. For example, in this embodiment, an active matrix method is adopted for driving the pixels. That is, on the above-mentioned transparent substrate SUB1, gate signal lines which extend in the row direction and are arranged in parallel in the column direction and drain signal lines which extend in the column direction and are arranged in parallel in the row direction are formed, and regions which are surrounded by these respective signal lines constitute pixel regions. Further, each pixel region includes a thin film transistor which is turned on in response to a scanning signal from the gate signal line and supplies a video signal from the drain signal line to the pixel electrodes PX and, at the same time, a counter voltage signal line which is served for supplying a signal which becomes reference with respect to the video signal to the counter electrodes CT is also formed.

Further, an orientation film AL2 is formed on a liquid-crystal-side surface of the transparent substrate SUB2. The orientation film AL2 is also a film which is directly brought into contact with the liquid crystal LC, wherein the direction of the initial orientation of molecules of the liquid crystal LC is determined by setting the rubbing direction.

Also with respect to the transparent substrate SUB2, for facilitating the explanation, the liquid crystal display device is depicted in a state that a black matrix, color filters and the like, for example, are omitted from the drawing.

In the liquid crystal display panel LCC having such a constitution, on a surface of the transparent substrate SUB1 opposite to the liquid crystal, a phase plate PS2, a phase plate PS1 and a polarizer PL1 are arranged in a sequentially laminated manner. Here, the phase plates may also be referred to as the phase difference plates.

The phase plate PS2, the phase plate PS1 and the polarizer PL1 are combined to function as a circulatory polarizer.

Further, on a surface of the transparent substrate SUB2 of the liquid crystal display panel LCC opposite to the liquid crystal, a phase plate PS3, a phase plate PS4 and a polarizer PL2 are arranged in a sequentially laminated manner. The phase plate PS3 and the phase plate PS4 function as a compensation film.

Here, although the liquid crystal display panel LCC is usually conceived as a panel in which the above-mentioned respective phase plates and polarizers are arranged (laminated) as the film constitution, in the explanation of the specification, for facilitating the explanation, the above-mentioned phase plates and polarizers are removed.

Various modifications are conceivable with respect to the polarizers PL1, PL2 and phase plates PS1 to PS4 as described later.

Further, on a back surface of the liquid crystal display panel LCC, the backlight BL is arranged by way of the phase plate PS2, the phase plate PS1 and the polarizer PL1 which function as a circulatory polarizer.

When the liquid crystal display device is used as the transmission-type liquid crystal display device, the backlight BL is turned on and the light TM of the backlight BL passes through the polarizer PL1, the phase plate PS1, the phase plate PS2, the liquid crystal display panel LCC, the phase plate PS3, the phase plate PS4 and the polarizer PL2 and is observed with naked eyes of a viewer. In this case, the passing of the light through the liquid crystal display panel LCC is performed through gaps defined between the pixel electrodes PX and the counter electrodes CT.

Here, in the liquid crystal display device adopting the lateral electric field driving, provided that the black display is performed when the voltage is not applied to the liquid crystal LC and the incident light from the back surface side is incident on the liquid crystal LC as the circulatory polarized light, by allowing the liquid crystal LC to have a given twist angle when the voltage is not applied to the liquid crystal LC, it is possible to enhance the transmissivity compared to a case in which the liquid crystal LC has no twist angle. The detail of the given twist angle is explained later.

When the liquid crystal display device is used as the reflection-type liquid crystal display device, the backlight BL is turned off and the light RM such as sunbeams, for example, which is incident from the viewer's side passes through the polarizer PL2, the phase plate PS4, the phase plate PS3, the liquid crystal display panel LCC and, thereafter, is reflected in the inside of the liquid crystal display panel LCC, and again passes through the phase plate PS3, the phase plate PS4 and the polarizer PL2 and is observed with naked eyes of a viewer. In this case, the reflection of light in the liquid crystal display panel LCC is performed by the pixel electrodes PX and the counter electrodes CT.

The above-mentioned embodiment is configured such that the pixel electrodes PX and the counter electrodes CT are formed on the same layer surface. However, it is needless to say that the substantially equal advantageous effects can be obtained by interposing an insulation layer between the pixel electrodes PX and the counter electrodes CT thus forming the pixel electrodes PX and the counter electrodes CT on different layers.

Further, in the above-mentioned embodiment, the light reflection function is imparted to the pixel electrodes PX and the counter electrodes CT. However, the present invention is not limited to such a constitution and the reflection function may be imparted to either one of the pixel electrodes PX and the counter electrodes CT. In this case, as a material of another electrodes to which the light reflection function is not imparted, a light transmitting conductive layer made of ITO (Indium Tin Oxide), for example, is used and the forming region constitutes the transmission region.

This embodiment uses the partial transmission-type liquid crystal display device and hence, as viewed in a plan view, the place where the reflection display is performed (reflection region RL) and the place where the transmission display is performed (transmission region) are arranged at different positions. In the reflection region RL, the reflection layer having the light reflection function (pixel electrodes PX and counter electrodes CT in this embodiment) is formed on any positions between the circulatory polarizer and the liquid crystal LC.

Here, it is desirable that the layer thickness of the liquid crystal LC in the transmission region is substantially equal to the layer thickness of the liquid crystal LC in the reflection region RL. Since the reflection film having the reflection function is not formed in the transmission region, the layer thickness of the liquid crystal LC may differ between the transmission region and the reflection region. However, the step per se between the transmission region and the reflection region RL is small and hence, the step is within the allowable range. It may be possible to intentionally provide the small step by taking the optical characteristic into consideration. Assuming the layer thickness of the liquid crystal LC in the reflection region RL as dr and the layer thickness of the liquid crystal LC in the transmission region as dt, it is preferable to set a relationship 0.75 dt≦dr≦1.1 dt. It is further desirable to set a relationship 0.9 dt≦dr≦1.1 dt. Even when the small step is formed irrespective of whether the step is formed intentionally or not, the liquid crystal display device of this embodiment explicitly differs from the conventional liquid crystal display device in which the layer thickness dt is positively set twice as large as the thickness dr.

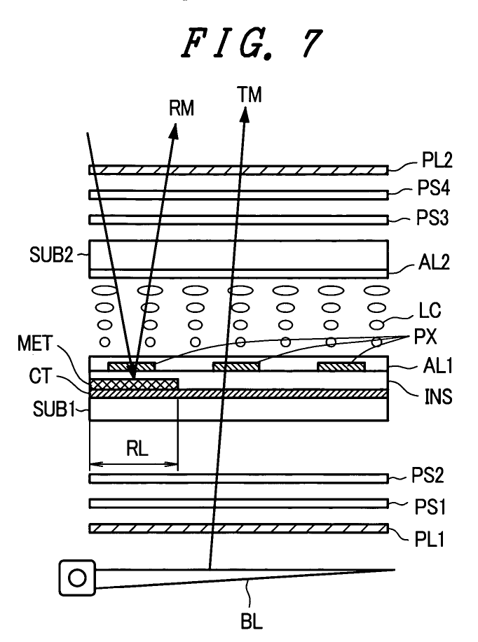

FIG. 7 is a cross-sectional view showing another embodiment of the liquid crystal display device according to the invention and corresponds to FIG. 6.

The constitution which makes this embodiment different from the embodiment shown in FIG. 6 lies in the liquid crystal display panel LCC. First of all, a counter electrode CT is formed over a substantially whole area of a pixel region (the counter electrode CT may extend over neighboring pixel regions), and pixel electrodes PX constituted of a group formed of a plurality of electrodes are formed on the counter electrode CT in an overlapped manner by way of an insulation film INS.

This embodiment can provide the constitution in which with the provision of the counter electrode CT and the pixel electrodes PX, the liquid crystal LC can be driven by an electric field having components substantially parallel to a surface of a transparent substrate SUB1 and, at the same time, the liquid crystal LC can be also driven by an electric field which is generated substantially orthogonal to the counter electrode CT in peripheral (edge) portions of the pixel electrodes PX.

Further, in such a constitution, in a reflection region RL which is formed in a portion of the pixel region, a reflection metal layer MET is formed separately from the pixel electrodes PX and the counter electrode CT. The reflection metal layer MET may be formed in a state that the reflection metal layer MET is directly brought into contact with an upper surface of the counter electrode CT, for example, and is held at a potential equal to a potential applied to the counter electrode CT.

The reflection metal layer MET which is allowed to perform the reflection of light is provided independently and both of the pixel electrodes PX and the counter electrode CT are formed of a light-transmitting conductive film made of ITO or the like and hence, it is possible to enhance a so-called numerical aperture of the pixel. Further, it is also possible to enhance an electric field density and hence, the liquid crystal display device can be driven with a low voltage.

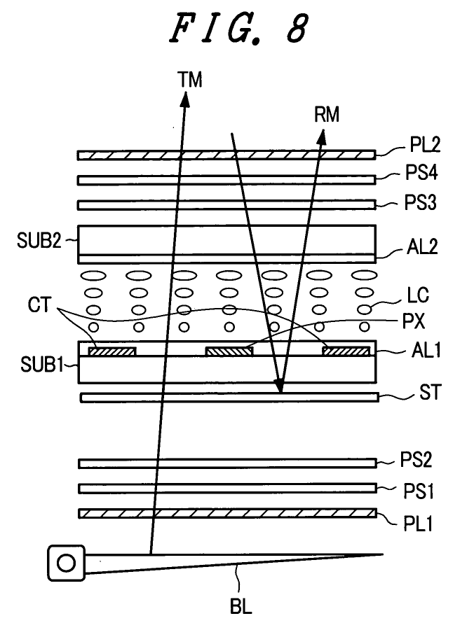

FIG. 8 is a cross-sectional view showing another embodiment of the liquid crystal display device according to the present invention and corresponds to FIG. 6. This embodiment is characterized in that the present invention is applied to a semi-transmission-reflection type liquid crystal display device.

The constitution which makes this embodiment different from the embodiment shown in FIG. 6 lies in that, first of all, a material of pixel electrodes PX and a counter electrode CT are formed with a light-transmitting conductive layer made of ITO or the like.

Further, for example, on a surface of a transparent substrate SUB1 opposite to the liquid crystal LC and between the transparent substrate SUB1 and a phase plate PS2, a semi-transmission-reflection film ST is arranged thus allowing the semi-transmission-reflection film ST to function as both of a transmission region and a reflection region over a whole area of a pixel region. The semi-transmission-reflection film ST is semi-transparent and possesses both of the transmission characteristic and the reflection characteristic. Accordingly, as viewed in a plan view, a place where the reflection display is performed and a place where the transmission display is performed have at least portions thereof partially overlapped to each other. In this embodiment, since the pixel electrodes PX and the counter electrode CT are formed of the light-transmitting conductive layer, the place which performs the reflection display and the place which performs the transmission display agree with each other. However, by forming apertures in the semi-transmission-reflection film ST thus forming such places partially, it is possible to form regions which are exclusively used for the transmission display. Further, by forming at least one of the pixel electrode PX and the counter electrode CT as the reflection layer, it is possible to form the region exclusively for the reflection display.

Here, in case of the semi-transmission-reflection type liquid crystal display device, the same place (point) as viewed in a plan view performs both of the reflection display and the transmission display and hence, eventually, it is possible to satisfy the condition that the layer thickness of the liquid crystal LC in the reflection region and the layer thickness of the liquid crystal LC in the transmission region are substantially equal.

Although, in this embodiment, the semi-transmission-reflection film ST is formed on the surface of the transparent substrate SUB1 opposite to the liquid crystal LC, the semi-transmission-reflection film ST may be formed between the transparent substrate SUB1 and the liquid crystal LC. That is, it is sufficient that the semi-transmission-reflection film ST is arranged at any place between the circulatory polarizer and the liquid crystal LC.

Further, the semi-transmission-reflection film ST may be realized by forming the reflection layer made of aluminum or the like as thin as possible such that the reflection layer allows light to pass therethrough. It is needless to say that, alternatively, films which form insulation layers or the like are stacked in multiple layers and film thicknesses of these films are controlled (by making use of a so-called interface reflection) so as to allow the stacked body to possess a function of the semi-transmission-reflection film ST. As such insulation films, it is possible to use films which are used for other usages such as a background film, a gate insulation film, an interlayer insulation film and a protective film, in the liquid crystal display panel LCC. It is needless to say that the semi-transmission-reflection film ST is formed separately from the films which are used for other usages.

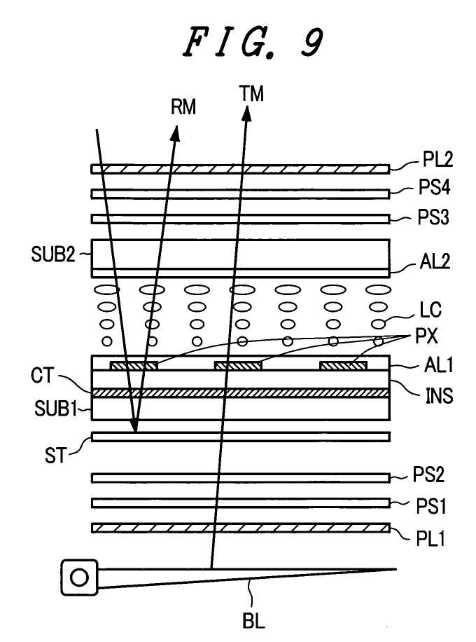

FIG. 9 is a cross-sectional view showing another embodiment of the liquid crystal display device according to the invention and corresponds to FIG. 6.

In the same manner as the embodiment shown in FIG. 8, a semi-transmission-reflection film ST is constituted to function as both of a transmission region and a reflection region over a whole area of a pixel region. For example, the semi-transmission-reflection film ST is arranged on a surface of a transparent substrate SUB1 opposite to the liquid crystal LC and between the transparent substrate SUB1 and a phase plate PS2. Here, as explained in conjunction with FIG. 8, it is sufficient that the semi-transmission-reflection film ST is arranged at any place between the circulatory polarizer and the liquid crystal LC.

Further, a counter electrode CT is formed over a substantially whole are a of a pixel region (the counter electrode CT may extend over neighboring pixel regions), and pixel electrodes PX constituted of a group formed of a plurality of electrodes are formed on the counter electrode CT in an overlapped manner by way of the insulation film INS. In this respect, this embodiment has the constitution substantially equal to the constitution shown in FIG. 7. To impart a light reflection function to the semi-transmission-reflection film ST, the pixel electrodes PX and the counter electrode CT are formed of a light transmitting conducive layer made of ITO or the like.

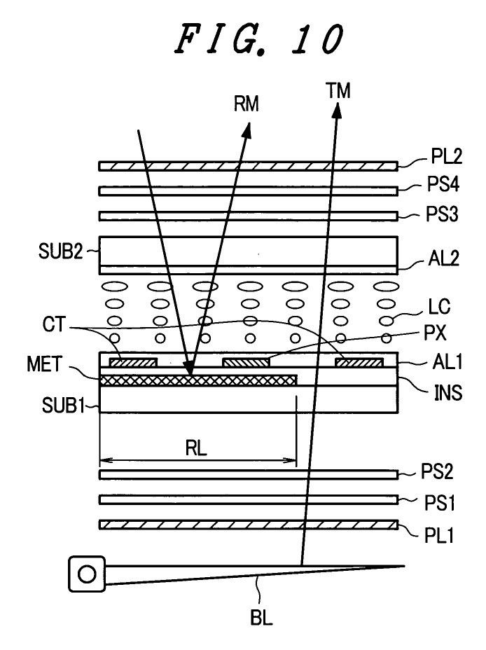

FIG. 10 is a cross-sectional view showing another embodiment of the liquid crystal display device according to the invention and corresponds to FIG. 6.

The constitution which makes this embodiment different from the embodiment shown in FIG. 6 lies in that below the pixel electrodes PX and the counter electrode CT which are formed on the same layer, a reflection metal layer MET which is held at a potential equal to a potential which is applied to the pixel electrodes PX by way of an insulation film INS is formed. Here, the reflection metal layer MET may have the same potential as the counter electrode CT.

A reflection region RL can be formed in a desired shape freely using the reflection metal layer MET. In view of the above, both of the pixel electrodes PX and the counter electrode CT are formed of a light-transmitting conductive film made of ITO or the like.

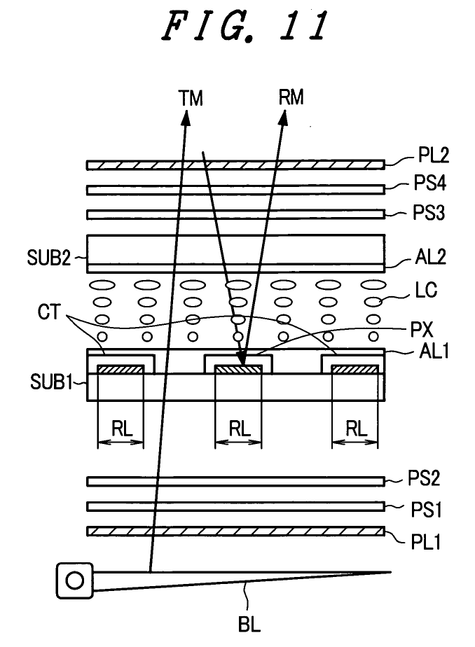

FIG. 11 is a cross-sectional view showing another embodiment of the liquid crystal display device according to the invention and corresponds to FIG. 6.

The constitution which makes this embodiment different from the embodiment shown in FIG. 6 lies in that, for example, both of pixel electrodes PX and a counter electrode CT which are formed on the same layer are formed of the sequential two-layered structure consisting of a conductive layer having a high light reflectance and a light-transmitting conductive layer and, at the same time, the light-transmitting conductive layer is formed in a state that the light-transmitting conductive layer covers the conductive layer having a high light reflectance. That is, as viewed in a plan view, the light-transmitting conductive layer slightly extends outwardly from a periphery of the conductive layer having a high light reflectance.

In such a case, out of the pixel electrodes PX and the counter electrode CT, it is possible to form a reflection region RL in a region where the conductive layer having high light reflectance is formed, while a transmitting region is formed in a remaining region.

Due to such a constitution, it is possible to obtain an advantageous effect that the transmission region can be sufficiently ensured without narrowing widths of respective electrodes.

The respective constitutions shown in the above-mentioned FIG. 6 to FIG. 11 are typical constitutions of the so-called lateral electric field liquid crystal display device. Accordingly, even when some modifications may be made with respect to the layer structure or the like, provided that the liquid crystal display device includes a pair of electrodes for generating electric fields, that is, the pixel electrodes PX and the counter electrode CT on a liquid-crystal-side surface of one substrate, it is possible to apply the present invention to the liquid crystal display device.

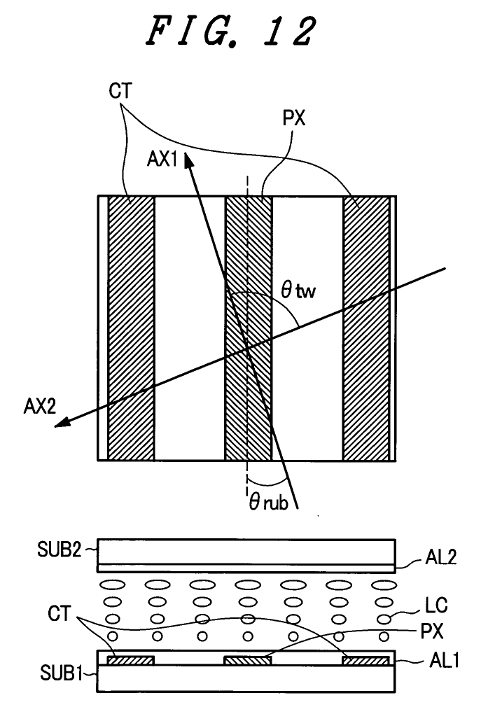

Next, a twist angle in an initial orientation state in the above-mentioned respective embodiments is explained. A lower portion of FIG. 12 is a cross-sectional view of a liquid crystal display panel LCC, while an upper portion of FIG. 12 is a plan view corresponding to the cross-sectional view. The plan view shows pixel electrodes PX and counter electrodes CT, wherein these electrodes PX, CT extend in the direction from an upper side to a lower side in the drawing and are arranged alternately. Here, although the twist angle is explained in FIG. 12 based on the embodiment shown in FIG. 6, the substantially equal twist angle is adopted by the embodiments shown in FIG. 7 to FIG. 11.

Further, an arrow indicated by a dotted line in the drawing indicates a rubbing direction AX1 of the orientation film AL1 on the transparent substrate SUB1 side and an arrow indicated by a solid line in the drawing indicates a rubbing direction AX2 of the orientation film AL2 on the transparent substrate SUB2 side.

In this case, an dielectric anisotropy Δε of the liquid crystal is set to a positive value (Δε>0) and a rubbing angle θrub and a twist angle θtw when a voltage is not applied to the liquid crystal LC are set as shown in FIG. 12.

Here, the rubbing angle θrub is an angle of the rubbing direction AX1 with respect to the extending direction of the pixel electrodes PX, while the twist angle θtw is a twist angle of the liquid crystal LC and in the embodiment, is set equal to an angle of the rubbing direction AX1 with respect to the rubbing direction AX2 when the voltage is not applied to the liquid crystal LC.

Here, a range in which the transmission display and the reflection display are compatible is set as a range in which both of the transmission display and the reflection display become bright with respect to the elevation of the voltage, and an optimum twist angle is considered from a viewpoint of the maximum transmissivity and the maximum reflectance in the range where the transmission display and the reflection display are compatible.

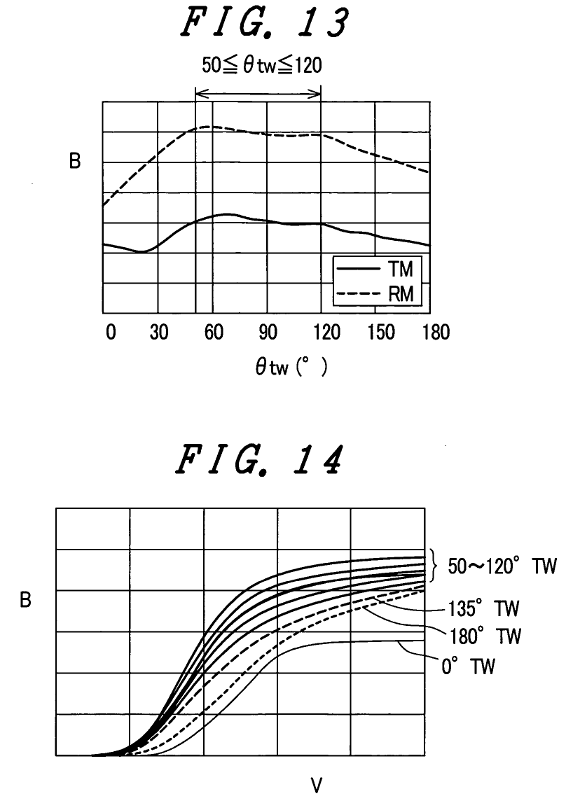

FIG. 13 is a graph obtained by the simulation, wherein the twist angle θtw is taken on an axis of abscissas and the brightness B is taken on an axis of ordinates. The characteristic indicated by a solid line shows the characteristic of the transmission light TM, while the characteristic indicated by a dotted line shows the characteristic of the reflection light RM. Here, in FIG. 13, the characteristic of the reflection light RM illustrates the brightness of reflection when the reflectance assumes the maximum value in the range where the transmission display and the reflection display become compatible. Further, the characteristic of transmission light TM illustrates the brightness of transmission when the reflectance assumes the maximum value in the range where the transmission display and the reflection display become compatible. Accordingly, the characteristic of the transmitting light TM does not always becomes the maximum. However, even when the characteristic curve is depicted by using the brightness with the maximum transmitting light TM although not shown in the drawing, it is possible to obtain a characteristic curve having the similar tendency.

As can be understood from these characteristic curves, the brightness B is high and also becomes substantially uniform when the twist angle θtw falls within a range of 50° to 120° and hence, it is possible to obtain favorable results with respect to both of the transmission characteristic and the reflection property in this range.

Further, FIG. 14 is a graph showing the characteristics of only the transmission display, wherein a voltage V is taken on an axis of abscissas and brightness B is taken on an axis of ordinates. Although FIG. 14 shows the characteristics when the twist angle θtw is set to 0° (0° TW), a value which falls within a range of 50° to 120° (50° to 120° TW), 135° (135° TW) and 180° (180° TW), it is surely understood that the high brightness is obtainable when the twist angle θtw becomes 50° or more. However, even when the twist angle θtw is excessively large, the characteristic is lowered. Accordingly, from a viewpoint of the transmissivity, it is desirable to set the twist angle θtw to a value which falls within a range of 50° to 120°. Further, the transmissivity becomes particularly high when the twist angle θtw is approximately 70° as can be understood from FIG. 13 and FIG. 3 and hence, it is more preferable to set the twist angle θtw to a value which falls within a range of 60° to 80°. Also in the characteristic curve which uses the maximum light transmitting light TM, the twist angle θtw exhibits similar ranges.

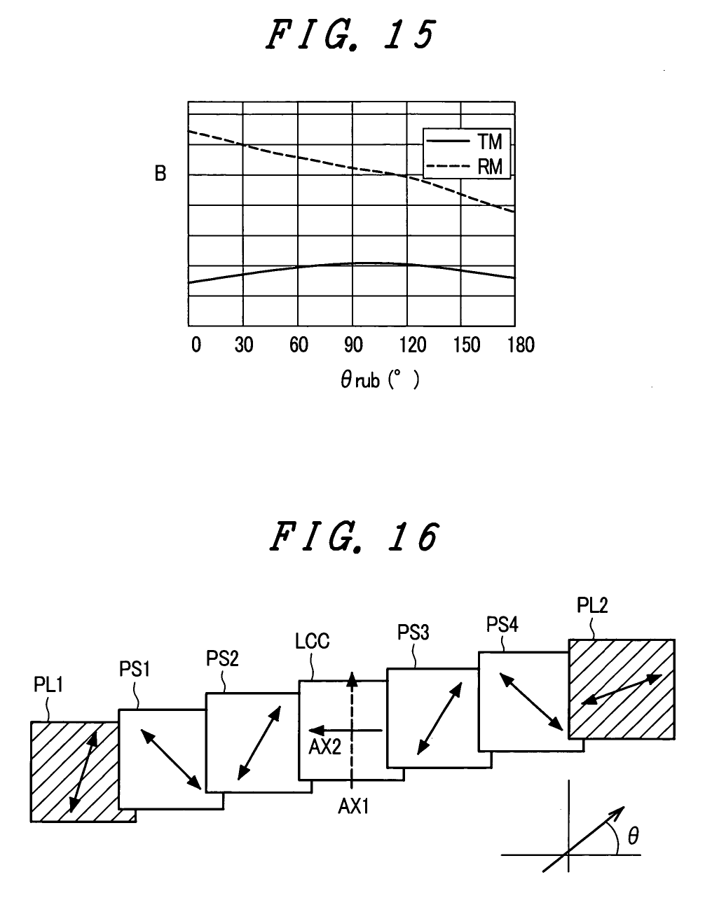

Further, FIG. 15 shows a graph in which the relationship between the brightness B and the rubbing angle θrub(°) is described provided that the above-mentioned twist angle θtw is set to a value which falls within a range of 50° to 120°. In FIG. 15, the rubbing angle θrub is taken on an axis of abscissas and the brightness B is taken on an axis of ordinates. Further, the characteristic indicated by a solid line shows the characteristic of the transmitted light TM, while the characteristic indicated by a dotted line shows the characteristic of the reflection light RM.

As can be understood from FIG. 15, it is apparent that it is desirable to set the rubbing angle θrub to a value which falls within a range of 0° to 15°. This is because that when the rubbing angle θrub does not fall within such a range, that is, becomes less than 0° or more than 15°, the brightness of the transmission display is lowered. However, even when the transmissivity is lowered more or less, there arises no drawback provided that the characteristic necessary on design is obtainable and hence, the use of the rubbing angle θrub which does not fall in the range of 0° to 15° is not impeded.

Next, the respective characteristics of phase plates, polarizers and the like which constitute an approximately circulatory polarizer on a reflection surface are explained. FIG. 16 is an exploded view showing the respective optical elements corresponding to the constitution shown in FIG. 6, for example. A polarizer PL1, a phase plate PS1, a phase plate PS2, a liquid crystal display panel LCC, a phase plate PS3, a phase plate PS4 and a polarizer PL2 are sequentially arranged from the left side (a side on which the backlight BL is arranged) in the drawing.

Further, in FIG. 16, respective absorption axis directions of the polarizers PL1, PL2, respective retardation axis directions of the phase plates PS1 to PS4, and rubbing directions AX1, AX2 of the liquid crystal display panel LCC are indicated as shown in the drawing in the inside of the respective optical elements. These respective directions are determined using the direction orthogonal to the extending direction of the pixel electrode PX (counter electrode CT) of the liquid crystal display panel LCC. These respective directions are described using the angle θ from the direction which constitutes the reference.

A film constitutional example of preferred phase plate, polarizer and the like when the retardation of the liquid crystal LC layer is 360 nm, for example, and the twist angle θtw of the liquid crystal LC layer is 90°, for example, is shown in Table 1.

Here, in Table 1, an upper polarizer corresponds to the above-mentioned polarizer PL2, an upper phase plate (2) corresponds to the above-mentioned phase plate PS4, an upper phase plate (1) corresponds to the above-mentioned phase plate PS3, a liquid crystal cell corresponds to the above-mentioned liquid crystal display panel LCC, a lower phase plate (1) corresponds to the above-mentioned phase plate PS2, a lower phase plate (2) corresponds to the above-mentioned phase plate PS1, and a lower polarizer corresponds to the above-mentioned polarizer PL1.

Further, axial angles, layer thicknesses and the like of the above-mentioned respective optical elements respectively show proper values in the constitution 1 to the constitution 4.

Since the actual film constitution is changed also depending on the setting of the twist angle θtw or the like, values in Table 1 can be changed provided that the approximately circulatory polarization is satisfied at the reflection surface (position where the reflection layer is formed, an opening portion or a gap at a position where the reflection layer is formed in case of the partial transmission type and at a position of the semi-transmission-reflection film in case of the semi-transmission-reflection film). The light is converted into the circulatory polarized light by the lower films basically and the light which passes through the liquid crystal layer is compensated by the upper films. In this respect, the upper films function as compensation films. Further, the film constitution also includes the symmetrical arrangement with respect to the electrode direction including the twist angle, the rubbing direction and the film arrangement.

Here, the number of films can be suitably changed. For example, the lower phase plates PS1, PS2 may be constituted of one plate by omitting the phase plate PS1 as in the case of the constitution 3 and the constitution 4 or may be constituted of two plates as in the case of the constitution 1 and the constitution 2. Further, although a specific example is omitted, the lower phase plates PS1, PS2 may be constituted of three or more plates.

TABLE 1

| | | consti- | consti- | consti- | consti- |
|---|---|---|---|---|---|
| | | tution1 | tution2 | tution3 | tution4 |
| upper | angle | 14° | 178° | 159° | 4° |
| polarizer | | | | | |
| upper | angle | 120° | 26° | 94° | 115° |
| phase | Δnd | 170 nm | 360 nm | 440 nm | 200 nm |
| plate (2) | | | | | |
| upper | angle | 85° | 130° | 15° | 100° |
| phase | Δnd | 110 nm | 270 nm | 110 nm | 130 nm |
| plate (1) | | | | | |
| liquid | AX1 | 90° | [symbol] | [symbol] | [symbol] |
| crystal cell | AX2 | 180° | [symbol] | [symbol] | [symbol] |
| | Δnd | 360 nm | [symbol] | [symbol] | [symbol] |
| lower | angle | 75° | [symbol] | 130° | [symbol] |
| phase | Δnd | 137 nm | [symbol] | 137 nm | [symbol] |
| plate (1) | | | | | |
| lower | angle | 142.5° | [symbol] | — | — |
| phase | Δnd | 275 nm | [symbol] | — | — |
| plate (2) | | | | | |
| lower | angle | 75° | [symbol] | 85° | [symbol] |
| polarizer | | | | | |

Here, the above-mentioned explanation is directed to the case in which the dielectric anisotropy Δε of the liquid crystal is positive (Δε>0). However, even when the dielectric anisotropy Δε of the liquid crystal is negative Δε (Δε<0), it is possible to use such liquid crystal by changing numerical values.

Here, although Table 1 describes the film constitution of the embodiment shown in FIG. 6, the embodiments shown in FIG. 7 to FIG. 11 adopt the substantially same technical concept and hence, the film constitution shown in Table 1 is applicable to the embodiments shown in FIG. 7 to FIG. 11 by changing numerical values when necessary.

In the embodiments explained in conjunction with FIG. 6 to FIG. 11, the polarizer PL2 may be arranged at any place provided that the polarizer PL2 is arranged on a front surface side than the liquid crystal LC. Accordingly, the polarizer PL2 may be formed on a liquid-crystal-side surface of the transparent substrate SUB2 using a coating-type polarization film, for example.

The polarizer PL1 may be also arranged at any place provided that the polarizer PL1 is arranged on a back surface side than the liquid-crystal LC. However, the polarizer PL1 may be arranged on a front surface side than the backlight. For example, the polarizer PL1 may be formed on a liquid-crystal-side surface of the transparent substrate SUB1 using a coating-type polarization film.

Also with respect to the phase plates PS1, PS2 which are arranged on the back surface side, provided that the phase plates PS1, PS2 have a function of converting the linear polarized light to the circulatory polarized light as a whole, the numbers of the phase plates PS1, PS2 are not limited. Further, the phase plates PS1, PS2 may be arranged at any places provided that the phase plates PS1, PS2 are arranged between the liquid crystal LC and the polarizer PL1. Accordingly, the phase plates PS1, PS2 may be formed on a liquid-crystal-side surface of the transparent substrate SUB1 using a coating-type phase film, for example.

Also with respect to the phase plates PS3, PS4 which are arranged on the front surface side, the numbers of the phase plates PS3, PS4 are not limited. The phase plates PS3, PS4 may be arranged at any places provided that the phase plates PS3, PS4 are arranged between the liquid crystal LC and the polarizer PL2. Accordingly, the phase plates PS3, PS4 may be formed on a liquid-crystal-side surface of the transparent substrate SUB2 using a coating-type phase film, for example.

Further, although the embodiments on the partial transmission type liquid crystal display device and the semi-transmission-reflection type liquid crystal display device have been explained in conjunction with FIG. 6 to FIG. 11, the present invention is also applicable to the transmission type liquid crystal display device. This is because that, in the lateral-electric-field driving type liquid crystal display device, even when the circulatory polarized light is incident on the liquid crystal layer from the back surface side, by imparting the twist angle to the liquid crystal when the voltage is not applied to the liquid crystal, it is possible to obtain the favorable transmissivity. In this case, in embodiments shown in FIG. 6 to FIG. 11, the present invention is applicable to the transmission type liquid crystal display device by changing the film having the light reflection function to a light-transmitting conductive layer or by eliminating the semi-transmission-reflection film ST.

The above-mentioned respective embodiments may be respectively used in a single form or in combination. This is because that the advantageous effects of the respective embodiments can be obtained independently or synergistically.

What is claimed is:

1. A liquid crystal display device comprising:
a first substrate which has a pixel electrode and a counter electrode;
a second substrate which is arranged to face the first substrate in an opposed manner;
a liquid crystal layer which is sandwiched between the first substrate and the second substrate;
an upper polarizer which is arranged at a front surface side than the liquid crystal layer; and
a lower polarizer which is arranged at a back surface side than the liquid crystal layer, wherein
the liquid crystal display device further includes a lower phase difference film which is arranged between the liquid crystal layer and the lower polarizer and converts a linearly polarized light to a circularly polarized light and an upper phase difference film which is arranged between the liquid crystal layer and the upper polarizer,
the liquid crystal layer is driven by an electric field which is generated between the pixel electrode of the first substrate and the counter electrode of the first substrate, and
a twist angle of the liquid crystal layer is within a range of 50° to 120° to perform a black display when a voltage is not applied.

2. A liquid crystal display device according to claim 1, wherein the twist angle of the liquid crystal layer is set to a value which falls within a range of 60° to 80° when the voltage is not applied.

3. A liquid crystal display device according to claim 1, wherein the liquid crystal display device includes a reflection region which performs a display by reflecting light which is incident from the front surface side and a transmission region which performs a display by allowing light which is incident from the back surface side to pass therethrough.

4. A liquid crystal display device according to claim 3, wherein the reflection region includes a reflection layer which reflects the light which is incident from the front surface side in place between the lower phase difference film and the liquid crystal layer.

5. A liquid crystal display device according to claim 3, wherein a layer thickness of the liquid crystal layer in the reflection region and a layer thickness of the liquid crystal layer in the transmission region are substantially equal.

6. A liquid crystal display device according to claim 1, wherein a semi-transmission-reflection film which is semitransparent and has both of a transmission characteristic and a reflection characteristic is arranged in place between the lower phase difference film and the liquid crystal layer.

7. A liquid crystal display device according to claim 1, wherein the liquid crystal display device is capable of performing a reflection display in which a display is performed by reflecting light which is incident from the front surface side and a transmission display in which a display is performed by allowing light which is incident from the back surface side to pass through, and a relationship 0.75 dt≦dr≦1.1 dt is established when a layer thickness of the liquid crystal layer at a place where the reflection display is performed is set as dr and a layer thickness of the liquid crystal layer at a place where the transmission display is performed is set as dt.

8. A liquid crystal display device according to claim 7, wherein a relationship 0.9 dt≦dr≦1.1 dt is established.

9. A liquid crystal display device according to claim 7, wherein the place where the reflection display is performed and the place where the transmission display is performed are arranged at places different from each other in a plan view.

10. A liquid crystal display device according to claim 7, wherein the place where the reflection display is performed and the place where the transmission display is performed have at least one portion thereof overlapped to each other in a plan view.

11. A liquid crystal display device according to claim 1, wherein the liquid crystal display device includes a backlight which is arrange data back surface side than the lower polarizer.
